(19) United States
(12) Patent Application Publication
(10) Pub. No.: US 2014/0088942 A1
(43) Pub. Date: Mar. 27, 2014

(54) MOLECULAR GENETIC DIAGNOSTIC SYSTEM

(71) Applicant: AMBRY GENETICS, Aliso Viejo, CA (US)

(72) Inventors: Xiang Li, Carlsbad, CA (US); Hong Lu, Lake Forest, CA (US); Hsiaomei Lu, Irvine, CA (US); Kelly Gonzalez, Aliso Viejo, CA (US); Melissa Parra, Woodland Hills, CA (US); Wenqi Zeng, Arcadia, CA (US); Elizabeth Chao, Newport Beach, CA (US); Charles Dunlop, Laguna Beach, CA (US)

(73) Assignee: AMBRY GENETICS, Aliso Viejo, CA (US)

(21) Appl. No.: 13/629,517

(22) Filed: Sep. 27, 2012

(51) Int. Cl. G06F 19/12

(52) U.S. Cl. CPC G06F 19/12
USPC 703/11

(57) ABSTRACT

A computer-implemented bioinformatics program annotates human genetic variants by integrating multiple sources of information. The program rapidly filters variants that are unlikely to play a role in the etiology of particular diseases. This filtering may be performed based on such annotations, on clinical profiles and family histories, and on analyses under various inheritance models, in order to classify human variants and identify mutations influencing patients' diseases.

### FIELD

Aspects of the subject technology relate to computational biology, genetics, and clinical diagnostics.

### BACKGROUND

Medical sequencing is an approach to discovery of genetic causes of complex disorders. Sequencing of a genome or portion thereof of individuals affected by a disease or with a trait of interest may be performed to determine the cause of common, complex traits.

Exome sequencing is a strategy by which the coding regions of a genome are selectively sequenced as an alternative to whole genome sequencing. The exome represents an enriched portion of the genome that can be used to search for variants with large effect sizes.

By sequencing the coding region, exome sequencing has the potential to be clinically relevant in genetic diagnosis due to current understanding of functional consequences in sequence variation. The functional variation that is responsible for both Mendelian and common diseases may be identified with high coverage in sequence depth.

### SUMMARY

Embodiments of computer-implemented bioinformatics programs and related methods are described herein. One such bioinformatics program annotates human genetic variants by integrating multiple sources of information. According to some embodiments, the bioinformatics program rapidly filters variants which do not play a role in the etiology of particular diseases. This filtering may be performed based on annotations or based on a family history inheritance model analysis in order to assist scientists and molecular diagnosticians to classify human variants and ultimately identify the underlying mutation leading to patients' genetic disease.

The subject technology is illustrated, for example, according to various aspects described below. Various examples of aspects of the subject technology are described as numbered clauses (1, 2, 3, etc.) for convenience. These are provided as examples and do not limit the subject technology. It is noted that any of the dependent clauses may be combined in any combination, or placed into any independent clause, e.g., clause 1 or clause 55. The other clauses can be presented in a similar manner.

1. A computer-implemented method of diagnosing a genetic influence for a condition in a proband, comprising:
by a processor and from a list of genetic variants, removing variants not compatible with a Mendelian inheritance model determined by an input to the processor and based on a family history of the proband;
from the list of variants, removing variants that are present in unaffected controls above a specified frequency and specified occurrence that are determined by the input; and
by a processor, identifying a genetic influence for the condition, based on one or more remaining variants in the list.

2. The method of clause 1, further comprising determining a treatment plan based on the genetic influence.

3. The method of clause 1, wherein the identifying a genetic influence comprises estimating a probability that one of more of the remaining variants significantly influences at least one of clinical signs or symptoms of the proband.

4. The method of clause 1, wherein the removing variants not compatible with the Mendelian inheritance model comprises comparing a genotype from the proband to a genotype from at least one family member.

5. The method of clause 1, wherein the removing variants not compatible with the Mendelian inheritance model further comprises removing a heterozygous variant of the proband that exists in at least one unaffected family member as a homozygous variant.

6. The method of clause 1, wherein the Mendelian inheritance model is a dominant model.

7. The method of clause 6, wherein the removing variants not compatible with the Mendelian inheritance model further comprises removing a heterozygous variant of the proband if it exists in at least one unaffected family member or does not exist in at least one affected family member.

8. The method of clause 6, wherein the removing variants that are present in unaffected controls comprises removing a candidate heterozygous variant that presents in at least one unaffected control as either a heterozygous or homozygous variant.

9. The method of clause 1, wherein the Mendelian inheritance model is a recessive model.

10. The method of clause 9, wherein the removing variants not compatible with the Mendelian inheritance model comprises removing a candidate homozygous variant that at least one of (a) presents in at least one unaffected family member or unaffected control as a homozygous variant or (b) does not present in at least one affected family member.

11. The method of clause 9, wherein the removing variants that are present in unaffected controls comprises removing a candidate pair of compound heterozygous variants that present in at least one unaffected control.

12. The method of clause 1, wherein the Mendelian inheritance model is a sex-linked recessive model.

13. The method of clause 12, wherein the removing variants not compatible with the Mendelian inheritance model comprises removing a candidate variant that at least one of (a) presents in at least one unaffected male family member or male unaffected control as a hemizygous variant, (b) presents in at least one unaffected female family member or female unaffected control as a homozygous variant, or (c) does not present in at least one affected family member.

14. The method of clause 1, wherein the list is an index list, and further comprising forming the index list, from a master list of more genetic variants than are in the index list, by the following steps:
annotating a description of variants based on locations of at least one of (a) mutations in respective genes, or (b) amino acid alterations in affected proteins;
annotating population frequencies of variants;
annotating disease information associated with variants;
annotating with evolutionary conservation indicators at variant positions; and
annotating at least one prediction of a deleterious effect of at least one variant.

15. The method of clause 1, wherein the list is an index list, and further comprising forming the index list, from a master list of more genetic variants than are in the index list, by the following steps:
from the master list, removing common variants that satisfy a user-defined threshold;
from the master list, removing variants in at least one intergenic region; and
from the master list, removing deep intronic variants and synonymous variants that do not have associated records in a selected database.

16. The method of clause 15, wherein common variants comprise single nucleotide polymorphisms (SNPs), deletions, insertions, and indels.

17. A computer implementation system for diagnosing a genetic influence for a condition in a proband, comprising:
an input module that, by a processor, receives an input from a user;
an inheritance filtering module that, by a processor, based on the input, and from a list of variants, removes variants not compatible with a Mendelian inheritance model, determined by an input to the processor, and based on a family history of the proband;
a control filtering module that, by a processor, based on the input, and from the list of variants, removes variants that are present in unaffected controls above a specified frequency and specified occurrence that are determined by the input;
an identifying module that, by a processor, identifies a genetic influence for the condition, based on one or more remaining variants in the list; and
an output module that, by a processor, outputs the one or more remaining variants to a display.

18. The computer implementation system of clause 17, further comprising a determining module that, by a processor, determines a treatment plan based on the genetic influence.

19. The method of clause 1, wherein the identifying module is configured to identify genetic influence by estimating a probability that one of more of the remaining variants significantly influences at least one of clinical signs or symptoms of the proband.

20. The computer implementation system of clause 17, wherein the input comprises a selection between a recessive model of Mendelian inheritance and a dominant model of Mendelian inheritance.

21. The computer implementation system of clause 17, wherein the input comprises a selection between an autosomal model of Mendelian inheritance, an X-linked model of Mendelian inheritance, and a Y-linked model of Mendelian inheritance.

22. The computer implementation system of clause 17, wherein the input comprises a selection of whether to allow de novo mutations.

23. The computer implementation system of clause 17, wherein the list is an index list, the computer implementation system further comprising a forming module that, by a processor, forms the index list, from a master list of more genetic variants than are in the index list.

24. The computer implementation system of clause 23, wherein the forming module, by a processor:
from the master list, removes common variants that satisfy a user-defined threshold;
from the master list, removes variants in at least one intergenic region; and
from the master list, removes deep intronic variants and synonymous variants that do not have associated records in a selected database.

25. A machine-readable medium comprising machine-readable instructions for causing a processor to execute a method comprising:
(1) receiving an input from a user;
(2) from a list of genetic variants, removing variants not compatible with a Mendelian inheritance model determined by an input to the processor and based on a family history of the proband;
(3) from the list of variants, removing variants that are present in unaffected controls above a specified frequency and specified occurrence that are determined by the input; and
(4) identifying a genetic influence for the condition, based on one or more remaining variants in the list.

26. The machine-readable medium of clause 25, wherein the list is an index list, and wherein the method further comprises forming the index list, from a master list of more genetic variants than are in the index list.

27. The machine-readable medium of clause 26, wherein forming the index list comprises:
within the list of variants, annotating a description of variants based on locations of at least one of (a) mutations in respective genes, or (b) amino acid alterations in affected proteins;
within the list of variants, annotating population frequencies of variants;
within the list of variants, annotating disease information associated with variants;
within the list of variants, annotating with evolutionary conservation indicators at variant positions; and
within the list of variants, annotating at least one prediction of a deleterious effect of at least one variant.

28. The machine-readable medium of clause 26, wherein forming the index list comprises:
from the master list, removing common variants that satisfy a user-defined threshold;
from the master list, removing variants in at least one intergenic region; and
from the master list, removing deep intronic variants and synonymous variants that do not have associated records in a selected database.

29. The machine-readable medium of clause 25, wherein the input comprises:
a selection between a recessive model of Mendelian inheritance and a dominant model of Mendelian inheritance;
a selection between an autosomal model of Mendelian inheritance, an X-linked model of Mendelian inheritance, and a Y-linked model of Mendelian inheritance; and
a selection of whether to allow de novo mutations.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the subject technology as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 shows an exemplary flow chart illustrating steps for annotating and filtering a vast number of raw variants to produce a short list with rich annotation, according to some embodiments of the present disclosure.

FIG. 2 shows an exemplary user interface to perform a filter program, according to some embodiments of the present disclosure.

FIG. 3 shows an exemplary user interface to provide results of a project, according to some embodiments of the present disclosure.

FIG. 4 shows an exemplary annotation work flow chart, according to some embodiments of the present disclosure.

FIG. 5 shows an exemplary work flow chart to determine a variant location and DNA level description, according to some embodiments of the present disclosure.

FIG. 6 shows an exemplary work flow chart to determine a variant type and DNA level description, according to some embodiments of the present disclosure.

FIG. 7 shows an exemplary work flow chart to determine a variant type and a first protein level description, according to some embodiments of the present disclosure.

FIG. 8 shows an exemplary work flow chart to determine a variant type and a second protein level description, according to some embodiments of the present disclosure.

FIG. 9 shows filtering based on autosomal dominant model for one family, according to some embodiments of the present disclosure.

FIG. 10 shows filtering based on autosomal recessive model for one family, according to some embodiments of the present disclosure.

FIG. 11 shows a conceptual block diagram illustrating an example of a system, according to some embodiments of the present disclosure.

FIG. 12 illustrates a simplified diagram of a system, according to some embodiments of the present disclosure.

### DETAILED DESCRIPTION

In a traditional genetic diagnosis, physicians base the selection of individual genes for testing on their examination of the patient and conduct genetic tests upon one or a few specific genes at a time. Pinpointing relevant genes based on a patient's clinical diagnosis has proven to be difficult due to a number of factors including lack of known disease genes associated with less common phenotypes, phenotypic variability, genetic heterogeneity, joint contribution of multiple genes to complex phenotypes, pleiotropy, variable penetrance, among many others.

In contrast, whole exome testing using sequencing is a much broader test targeting the exons of nearly all the genes in the human genome (over 20,000). A large number of genetic diseases are caused by mutations located in the exons, which are the regions of genes that code for proteins.

The exome is the part of the genome formed by exons, the coding portions of genes that are expressed. Providing the genetic blueprint used in the synthesis of proteins and other functional gene products, the exome is the most functionally relevant part of the genome, and, therefore, the most likely to contribute to the phenotype of an organism. The exome of the human genome consists of roughly 180,000 exons constituting about 1% of the total genome, or about 30 megabases of DNA. Though comprising a very small fraction of the genome, mutations in the exome are thought to harbor 85% of disease-causing mutations. Thus, exome sequencing is an efficient strategy to determine the genetic basis of many Mendelian or single gene disorders.

A robust approach to sequencing the complete coding region (exome) has the potential to be clinically relevant in genetic diagnosis due to current understanding of functional consequences in sequence variation. One goal of this approach is to identify the functional variation that is responsible for Mendelian diseases, such as Miller syndrome and hereditary intellectual disability, without the high costs associated with whole-genome sequencing, while maintaining high coverage in sequence depth.

Exome sequencing has the potential to locate causative genes in complex diseases, which previously has not been possible due to limitations in traditional methods. Targeted capture and massively parallel sequencing represents a cost-effective, reproducible, and robust strategy with high sensitivity and specificity to detect variants causing protein-coding changes in individual human genomes.

There are multiple technologies available to undertake methods to identify causal genetic variants associated with disease. Each technology has its own technical, financial, and throughput limitations. Microarrays, for example, require hybridization probes of known sequence and are therefore limited by probe design and thus prevent the identification of genetic changes that can be detected. Massively parallel sequencing technologies used for exome sequencing, on the other hand, make it now possible to identify the cause of many unknown diseases by screening thousands of loci at once. This technology addresses the present limitations of hybridization genotyping arrays and classical sequencing.

Exome sequencing has become increasingly practical with the falling cost and increased throughput of whole genome sequencing. Even by only sequencing the exomes of individuals, a large quantity of data and sequence information is generated which requires a significant amount of data analysis. Challenges associated with the analysis of this data include changes in programs used to align and assemble sequence reads. Various sequence technologies also have different error rates and generate various read-lengths which can pose challenges in comparing results from different sequencing platforms.

Individual whole exome sequencing can generate over 10,000-100,000 human variants. Disclosed herein are solutions for interpreting the vast number of variants and distinguishing the causative mutation(s) from those which do not play a role in the disease etiology of interest. While the present disclosure may be applied to analysis of exome sequencing results, the techings provided herein may be applied to one or more whole entire genomes or portions thereof.

Common complex diseases can have heterogeneous descriptions based on informal assembly of component phenotypes into the disease description. Given this heterogeneity of the features that can be ascribed to a disease, and because the principles of this model are not limited to “diseases” as that term is used in the art, the disclosed model and methods can be used in connection with “traits.” The term trait is intended to encompass observed features that may or may not constitute or be a component of an identified disease. Such traits can be medically relevant and can be associated with elements just as diseases can.

The disclosed models, and disclosed methods based on the models, can be used to generate valuable and useful information. At a basic level, identification of elements (such as genetic variants) that are associated with a trait (such as a disease or phenotype) provides greater understanding of traits, diseases, and phenotypes. Thus, the disclosed models and methods can be used as research tools. At another level, the elements associated with traits through use of the disclosed model and methods are significant targets for, for example, drug identification and/or design, therapy identification and/or design, subject and patient identification, diagnosis, prognosis as they relate to the trait. The disclosed models and methods will identify elements associated with traits that are more significant or more likely to be significant to the genesis, maintenance, severity, and/or amelioration of the trait. The display, output, cataloging, addition to databases, and the like of elements associated with traits and the association of elements to traits provides useful tools and information to those identifying, designing and validating drugs, therapies, diagnostic methods, prognostic methods in relation to traits.

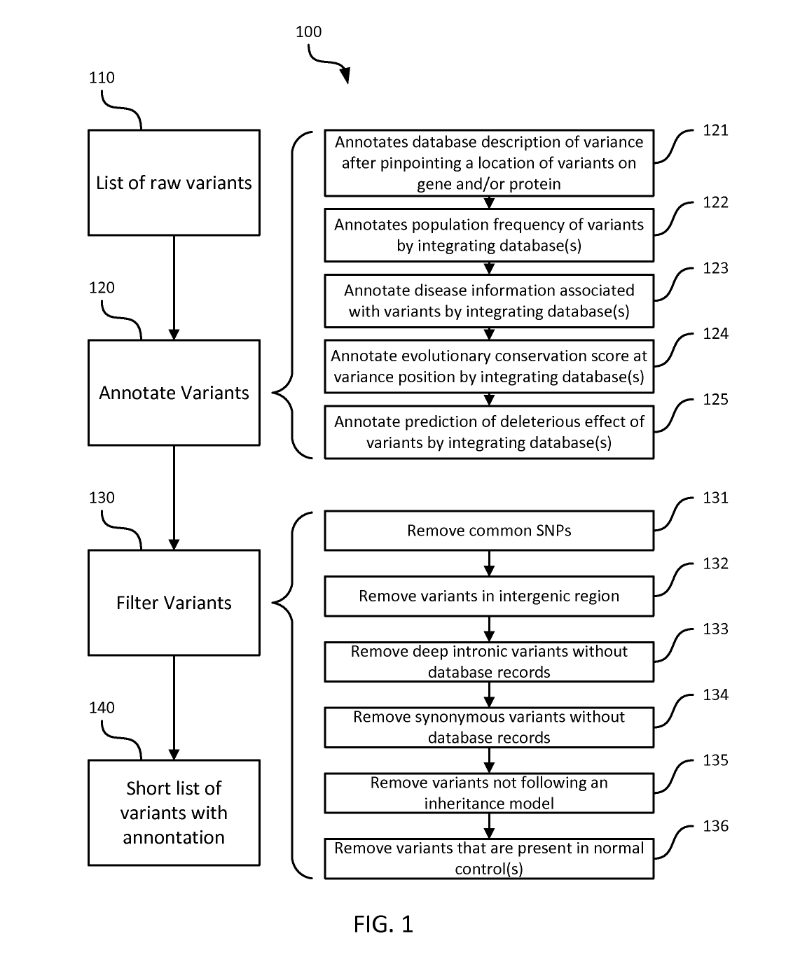

According to some embodiments, various steps of a program 100 may be performed to annotate or filter variants in the process of narrowing a broad set of variants. According to some embodiments, as shown in FIG. 1, a raw variant phase 110 provides a large number of variants.

According to some embodiments, as shown in FIG. 1, an annotation phase 120 causes the variants from the raw variant phase 110 to be annotated. The annotation phase 120 may be implemented by a stand-alone program and may be performed with or without respect to a given patient. The annotation phase 120 may be performed with respect to a list of raw variants or to a list or variants that are the product of a filtering phase.

According to some embodiments, the annotation phase 120 is performed prior to the filtering phase 130. The filtering phase 130 may be informed by the annotation provided in the annotation phase 120. For example, comparison or analysis performed during the filtering phase 130 may make reference to one or more annotations provided in the annotation phase 120.

According to some embodiments, step 121 is performed prior to steps 122, 123, 124, and 125. Steps 122, 123, 124, and 125 can be performed in any order. During the annotation phase 120, an index list may be formed from a master list by implementing one or more of steps 121-125.

According to some embodiments, steps 131, 132, 133, and 134 are performed prior to step 135. For example, variants may be removed from a master list based on characteristics of each variant without respect to a particular proband. Performance of the steps of the filtering phase 130 in this manner reduces the number of variants that are to be filtered based on one or more inputs with respect to a particular proband. This order of steps may improve efficiency, cost, and speed of analysis by not requiring that every variant by filtered with respect to a particular proband. According to some embodiments, step 135 is performed prior to step 136. Steps 131, 132, 133, and 134 can be performed in any order. During the filtering phase 130, an index list may be formed from a master list by implementing one or more of steps 131-136.

According to some embodiments, the annotation phase 120 may be performed prior to or after the filtering phase 130. According to some embodiments, any number (e.g., all or less than all) of the steps 121-125 of annotation phase 120 may be performed. For example, at least one of steps 121-125 may be performed. By further example, at least two of steps 121-125 may be performed. The steps of the annotation phase 120 may be performed in any order. According to some embodiments, any number (e.g., all or less than all) of the steps 131-136 of filtering phase 130 may be performed. For example, at least one of steps 131-136 may be performed. By further example, at least two of steps 131-136 may be performed. The steps of the filtering phase 130 may be performed in any order.

According to some embodiments, as shown in step 121 of FIG. 1, the program 100 provides a computational program to annotate any raw variant call accurately at a given genomic coordinate. For example, a variation from nucleotide base G to nucleotide base A (G>A) at Chromosome 3: 37090446 may be annotated. Based on the genomic coordinates of each variant, the program can locate the position of the variant within the human genome. By integrating with input (e.g., genomic context of genes and messenger RNAs transcripts) obtained from one or more databases, variants can be classified into the following categories: variants which sit within (i) intergenic regions; (ii) non-coding regions of genes (iii) the coding DNA sequence (CDS) of a gene. For example, the National Center for Biotechnology Information (NCBI) GenBank database may be used to make such classifications. According to some embodiments, intergenic variants are not annotated since they are not within genes, and therefore do not contain mRNA transcript, DNA, or protein information. However, variants within genes (ii and iii) are annotated with inputs (e.g., nomenclature) from the database, such as gene name, transcript ID, and description of variants on DNA level. For example, the Human Genome Variation Society (HGVS) may provide such nomenclature. For example, the above variant is annotated as MLH1 (gene) NM_{—}000249 (transcript RefSeq ID) c.2041G>A (HGVS nomenclature). Variants in CDS (iii) are further annotated with nomenclature (e.g., from HGVS) on the protein level. For example, the above variant is further annotated as NP_{—}000240 (protein RefSeq ID) p.A681T (HGVS nomenclature). A DNA level description reveals the variant location on the gene transcript, such as 5′-untranslated region (5′ UTR), intron, exon, and 3′-untranslated region (3′ UTR). The DNA level description also indicates the type of variants: substitution, insertion, deletion, or indels. A protein level description includes the variant position on the protein sequence, and the amino acid changes from wild type and mutant sequences. It also indicates the corresponding type of variants (substitution, insertion, deletion, indels, or frame shift) within the protein sequence. According to some embodiments, variants located on multiple overlapping genes or transcripts are annotated based on the individual gene or transcript, respectively.

According to some embodiments, as shown in step 122 of FIG. 1, the program 100 further annotates how frequently a given variant has been observed in the general population by integrating the population frequency information from multiple public databases, such as dbSNP, 1000 Genomes Project, and the National Heart, Lung, and Blood Institute (NHLBI) Exome Sequencing Project (ESP) databases. The annotation of this step provides a database accession number such as dbSNP refSNP ID, the allele count, and the frequency of the variant.

According to some embodiments, as shown in step 123 of FIG. 1, a given variant is annotated with any available associate clinical or disease-related information from one or more databases, such as the Human Gene Mutation Database (HGMD), the Online Mendelian Inheritance in Man (OMIM), among others.

According to some embodiments, as shown in step 124 of FIG. 1, a given variant is annotated with information indicating how conserved the variant is throughout evolution at the nucleotide and amino acid position by providing a multiple species alignment.

According to some embodiments, as shown in step 125 of FIG. 1, the program annotates in silico predictions of the deleterious effect of variants by integrating available in silico programs. Such programs could include SIFT (Sorting Intolerant From Tolerant) and Polyphen precomputed databases.

According to aspects of the present disclosure, provided is a filtering phase 130 to reliably remove irrelevant variants. Any number (e.g., all or less than all) of the filtering steps disclosed herein may be performed. The steps of the filtering phase 130 may be performed in any order.

According to some embodiments, as shown in step 131 of FIG. 1, common variants, such as single nucleotide polymorphisms (SNPs), deletions, insertions, and indels, are removed. According to some embodiments, the qualification of a variant as “common” requires satisfaction of one or more of at least two criteria.

According to some embodiments, a variant may be evaluated to determine whether it has a sufficiently significant frequency. As used herein, “frequency” means the proportion of individuals in a population with a given genotype. For example, frequency may be calculated as the number of individuals in a population with a given genotype divided by the total number of individuals in the population. Frequency may be expressed as a ratio or percentage.

According to some embodiments, a variant may be evaluated to determine whether it has been observed in a minimum number of individuals among the general population (i.e. number of occurrences). As used herein, “occurrence” means a number of individuals in a population with a given genotype. For example, occurrence may be numerated as an integer number of individuals in a population with a given genotype. Qualification of a variant based on occurrence may avoid problems introduced by occurrences that are caused by errors. For example, a single computational error may incorrectly contribute to the frequency of a variant. Where the population is small such a single error may significantly impact the frequency calculation. By requiring the occurrence to be at least one (for example) or greater, the impact of such a single computational error may be avoided. By requiring satisfaction of both a frequency threshold and an occurrence threshold, variants may be more accurately and properly filtered.

According to some embodiments, each evaluation (e.g., frequency and occurrence) may be made as a comparison to a predetermined or user-selected threshold. Separate thresholds may be applied, for example, based on an inheritance model to be applied. For example, a default minimum frequency and minimum number of occurrences are 1% and 5 times respectively for the recessive model, and 0.1% and 3 respectively for the dominant model. The thresholds can be modified by a user based on an input by the user.

According to some embodiments, as shown in step 132 of FIG. 1, variants in the intergenic region are removed.

According to some embodiments, as shown in step 133 of FIG. 1, deep intronic variants without records in one or more given databases are removed. For example, HGMD/OMIM database may be referenced. As used herein, “deep intronic variant” means a variant in a position located in an intronic region and a given distance away from any splicing junction. For example, the distance may be at least 2 bp from any splicing junction. The distance may be predetermined or user-selected. Because many deep intronic mutations can destroy splicing signals and have deleterious effects, important causative mutations to a given genetic disease can be removed by mistake. As a remedy, those known to be associated with disease based on database (e.g., HGMD/OMIM) records are not removed.

According to some embodiments, as shown in step 134 of FIG. 1, synonymous variants without records in one or more given databases are removed. For example, HGMD/OMIM database may be referenced. As used herein, “synonymous variant” means a change in the CDS region that codes for an amino acid in a protein sequence, but does not change the encoded amino acid. A synonymous change is generally benign, but sometimes can cause disease due to codon usage bias or loss of splicing signals. Therefore, not all synonymous variants are removed.

According to some embodiments, as shown in step 135 of FIG. 1, variants not compatible with a Mendelian inheritance model based on family history are removed. For each affected person, each variant is checked by comparing the genotype from the person to the genotypes from his/her family members (e.g., parents) and examine if it is consistent with the Mendelian inheritance model. The inheritance model may be predetermined or user-selected. For example, for a dominant model with full penetrance, the program removes a heterozygous variant in the proband if it exists in any one of unaffected family member(s) or does not exist in any one of the other affected family member(s). By further example, for a recessive model, the program removes a heterozygous variant in the proband if it exists in any one of the unaffected family member(s) as a homozygous variant, etc.

According to some embodiments, as shown in step 136 of FIG. 1, variants that are present in normal controls are removed. As used herein, a variant “is present in” or “presents in” a sample when the variant is identifiable in the genotype or the phenotype of the sample. Unaffected individuals' exome data may be collected through research, experimentation, or reference to external public databases, such as the database of Genotypes and Phenotypes (dbGaP), to build normal control data. For example, for a dominant model, the program removes a candidate heterozygous variant if it shows up in at least one normal control as either a heterozygous or homozygous variant. By further example, for a recessive model, the program removes a candidate homozygous variant if it shows up in at least one normal control as a homozygous variant. By further example, for the program removes a candidate pair of compound heterozygous variants if they both show up in at least one normal control.

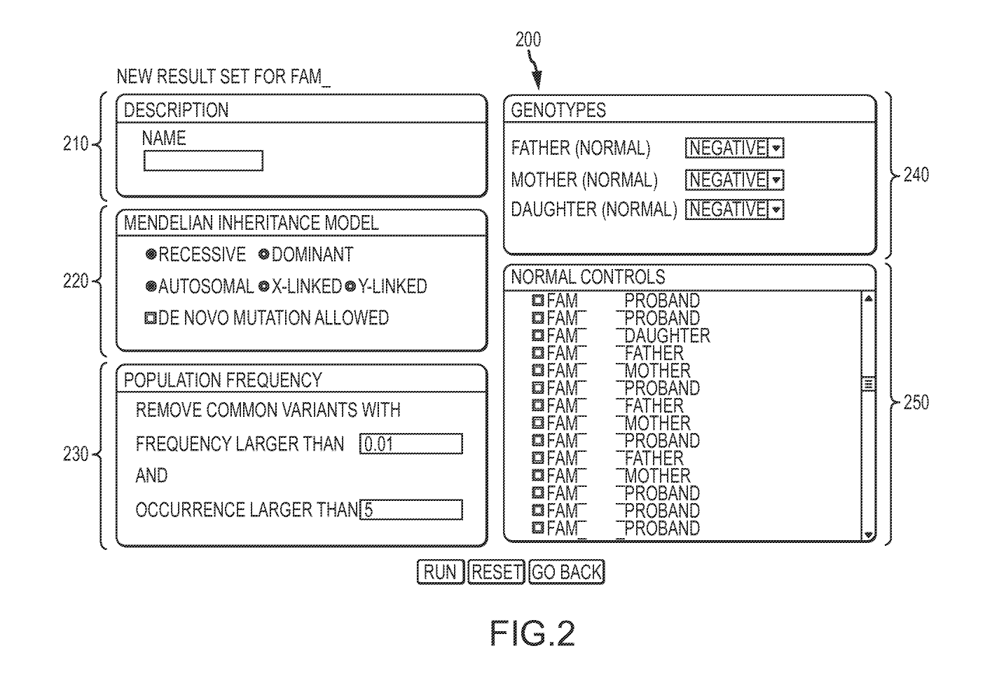

According to some embodiments, as shown in FIG. 2, an input interface 200 is provided, embodying the filtering method disclosed herein. The interface may be provided to a user at a display, terminal, or personal computer, and utlilizing a local or wide area network. Various predetermined or user-selected options selected via the interface, allow a medical team or external clinicians to efficiently narrow down the total variant list to a small number of variants (1-100) with rich annotation.

According to some embodiments, as shown in FIG. 2, one or more descriptions 210 of the project to be performed may be input by a user. The description 210 may identify a proband by a unique identifier (e.g., name, date, reference number, etc.).

According to some embodiments, as shown in FIG. 2, one or more inheritance model selections 220 may be used to define the Mendelian inheritance model to be applied in the project. For example, an election between recessive or dominant models may be made. By further example, an election between autosomal or X/Y-linked models may be made. By further example, an election regarding whether to allow for de novo mutation may be made.

According to some embodiments, as shown in FIG. 2, one or more variant frequency selections 230 may be used to define one or more thresholds to determine whether a given variant is sufficiently common. For example, a frequency value, range, or threshold may be defined. By further example, an occurrence value, range, or threshold may be defined.

According to some embodiments, as shown in FIG. 2, one or more family history selections 240 may be used to define genotypes manifesting within a proband's family. For example, an indication may be provided with regard to whether one or more given family members exhibit a certain character. For example, a “positive” or “negative” indication may be given for each family member considered. Any number of family members may be considered (e.g., parents, children, cousins, aunts, uncles, nieces, nephews, etc.).

According to some embodiments, as shown in FIG. 2, one or more control selections 250 may be used. Options for control selections 250 may be made available for selection based on unaffected individuals' exome data collected through research, experimentation, or reference to external public databases.

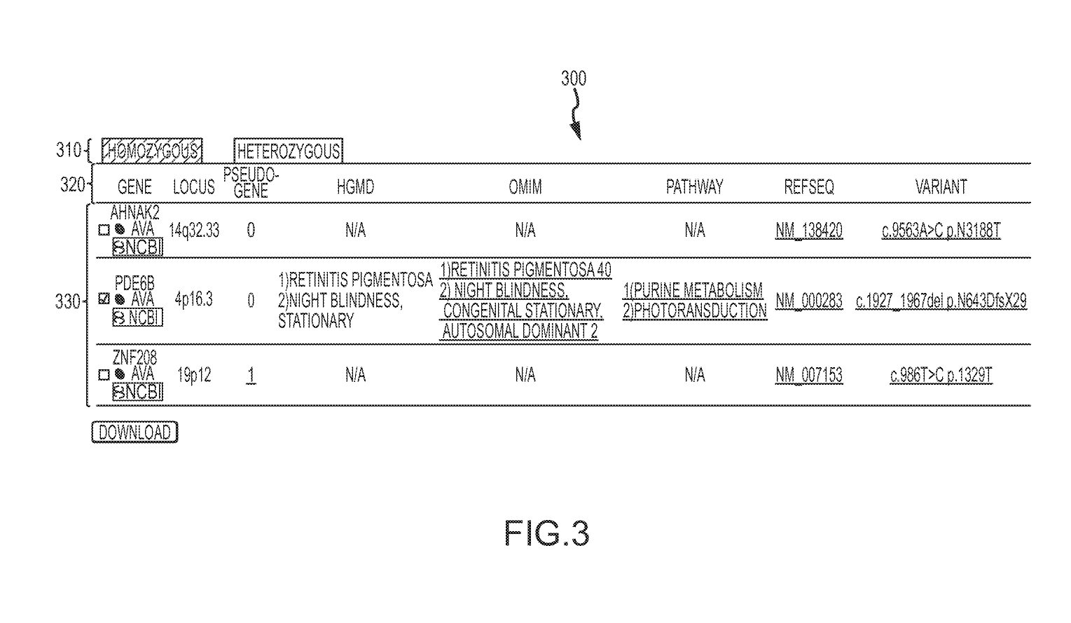

According to some embodiments, as shown in FIG. 3, an output interface 300 may provide results of a project for a patient. The results may be output to a display accessible or viewable by a user. The output may be manipulated by the user. The results may be categorized based on one or more category selections 310, such as a selection that distinguishes between heterozygous or homozygous variants. The results may further contain data categories 320 that separately provide details regarding members of a candidate list 330. Data categories 320 may include one or more indicia for gene, locus, pseudo-gene, HGMD, OMIM, biological pathway, NCBI reference sequence (RefSeq), and variant. The candidate list 330 includes a set of variants that were not excluded by filtering steps performed. The output includes data collected by annotation of variants and displayed according to data categories 320. For example, in FIG. 3, the patient has been diagnosed to have retinitis pigmentosa. Through an interface 300, an autosomal recessive inheritance model was run. Three candidate genes were reported out in minutes. PDE6B is one of the known genes, of which mutations can cause retinitis pigmentosa, as indicated by HGMD records.

In the following detailed description, numerous specific details are set forth to provide a comprehensive understanding of the subject technology. It will be apparent to one of ordinary skill in the art that the subject technology may be practiced without some of these specific details. In other instances, well-known structures and techniques have not been shown in detail so as not to obscure the subject technology.

The various aspects of the present invention mentioned above, as well as many other aspects of the invention, are described in greater details below.

### Annotating Variants

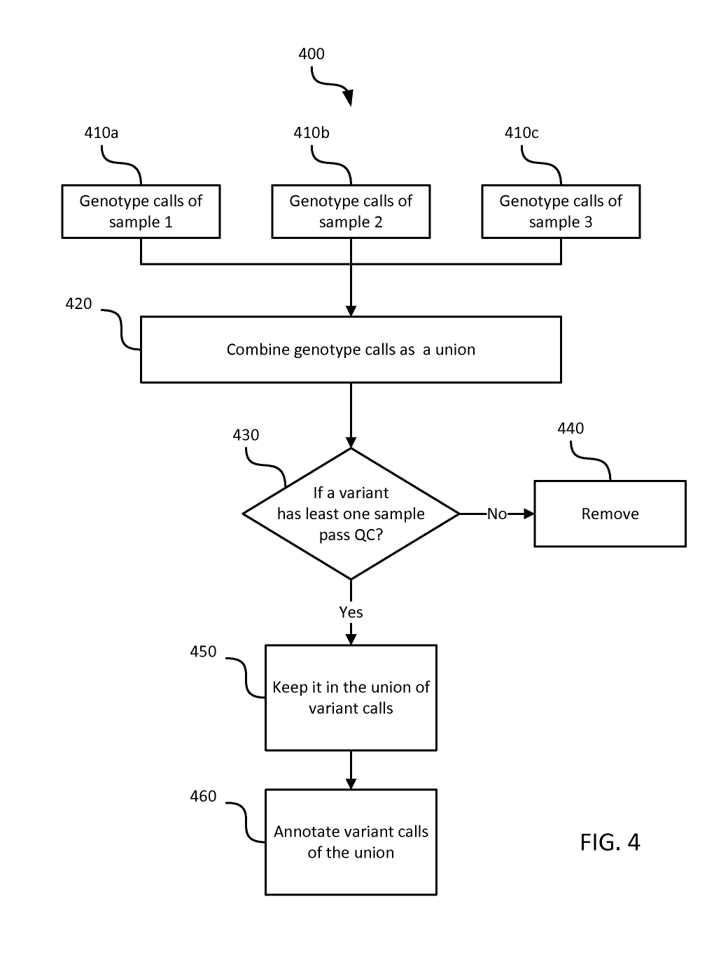

According to some embodiments, as shown in FIG. 4, an annotation work flow chart 400 allows users to include more than one human samples (e.g., 410a-c) into a project. For example, two, three, four, five, or a greater number of members of a family may be included in a project. If there is more than one sample in the project, the genotype may call on each position of each sample are combined as a union in step 420. For a position, in step 430, if at least one sample has a variant call with coverage ≧10 and quality score ≧20, this position may remain as the union of variant list in step 450, and may be annotated in step 460. Otherwiese, it may be removed in step 440.

According to some embodiments, a variant report is constructed as a union for all samples instead of constructing them separately. Because not every sample would have a variant call on any particular position, the coverage information at this position would be missing in the individual variant report for these samples. Because not every sample would have a variant call passing the coverage and quality score threshold, the variant would be missing in the individual variant report, and will be considered as a wild-type mistakenly.

According to some embodiments, the program may annotate variants according to the genomic coordinates. The annotation starts with locating the position onto gene transcript regions and provides the detail description of the variant type and changes on both DNA and protein level. Once the annotation of relevant gene transcript is obtained, it will be used to search against public databases to obtain the relevant population frequency and disease-related information. The detail annotation algorithm is described in the following section.

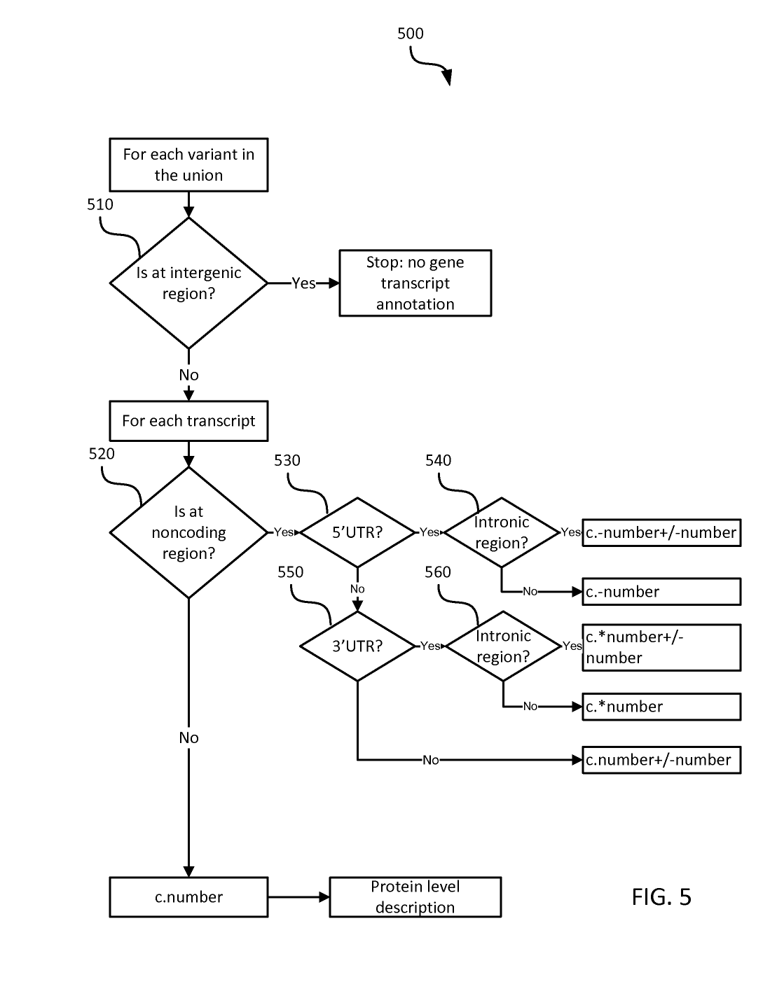

The process of retrieving the relevant gene transcript information involves three steps to determine if a variant is within (1) intergenic region, (2) noncoding regions of gene transcripts, or (3) coding DNA sequence (CDS) regions. Each step is followed by the corresponding annotation for the position of gene transcription and translation if it applies. Besides the position annotation, types of variants are also provided. According to some embodiments, as shown in FIG. 5, an annotation work flow chart 500 allows users to determine a variant location and DNA level description. The method details will be described in the order of the annotation process in the following three subsections. The annotation methods according to variant types (substitution, insertion, deletion, indel, and frame shift) are listed below.

### Intergenic Region

According to some embodiments, as shown in step 510 of FIG. 5, the program determines if the variant position is within either an intergenic region or any gene transcript region. The genomic coordinate of a variant is given from variant reports. The information includes at which chromosome a variant is located and where it is located on the chromosome. Given the identification of the chromosome at which a variant is located, a list of gene transcripts on the chromosome can be obtained by matching the chromosome against one or more entire gene transcript location databases. The list of gene transcripts may be sorted according to chromosome coordinates of each gene transcript starting and ending position. Given the chromosomal coordinates and the sorted gene transcript list, the program can determine if the variant is located inside of any gene transcript. This is done by checking if the variant coordinate is equal to or greater than the gene transcript starting position and/or equal to or less than the gene transcript ending position. With this, a list of gene transcripts where the variant is located can be obtained. If this list is not empty, gene name and transcript RefSeq ID are recorded in the annotation report of this variant. The detailed information of the variant location onto each transcript may be provided in the next two steps. Otherwise, the gene transcript annotation of this variant will stop here.

### Non-Coding Region

According to some embodiments, once a list of gene transcript(s) within which the variant is located is obtained, the second checkup step can be performed. The program may provide DNA-level description of a variant according to its location on each gene transcript, including intronic, 5′-untranslated (5′ UTR), and 3′-untranslated regions (3′ UTR). For each gene transcript on the list, the mRNA and CDS structures are retrieved by searching the transcript RefSeq ID against the entire gene transcript public database.

According to some embodiments, the mRNA structure of each gene transcript comprises a list of chromosomal segments. Each segment represents an exonic region, and its location is indicated by a pair of genomic coordinates for mRNA transcription starting and ending position, respectively. The CDS structures are described with the same fashion as mRNA structures by listing all pairs of protein translation starting and ending position.

According to some embodiments, given the chromosomal coordinate of the variant and the mRNA structure of each gene transcript, the program can determine if the variant is located on either intronic or exonic region. This is done by scanning all pairs of transcription starting and ending coordinates and then checking if the variant position is in between the starting and ending coordinates. If the variant position is equal to or greater than the starting position and is equal to or less than the ending position, this variant is located in the exonic region. Otherwise, it is located in the intronic region.

According to some embodiments, the program can determine if the variant is located in a protein coding region or non-coding region by comparing the variant coordinate to CDS structure coordinates. There are three categories of non-coding region: (i) if a variant coordinate is less than the starting position of the 1st pair coordinates of a CDS structure, it is located in the 5′ UTR (see step 530). (ii) If a variant coordinate is greater than the ending position of the last coordinate pair of a CDS structure, it is located in the 3′ UTR (see step 560). (iii) If a variant is not classified as either one of the UTR regions, it is located in an intronic region (see steps 540 and 560). Variants belongs to these three categories have only DNA level description. The detailed annotation process is described herein. If a variant does not satisfied any of the above criteria, then it is located on CDS regions.

According to some embodiments, if a variant is in 5′ UTR region, the DNA level description is as “c.-number”, where the number is an integer number, which indicates the distance between the variant to the 1st coding nucleotide. It is obtained by counting the number of bases from the variants position (or the closest starting position of exon pair coordinates, if a variant is on the intronic region) to the ending position of the pair coordinates where the variant (or the closest starting position) is located, and then adding the length of each following coordinates pair until reaching the 1st coding nucleotide.

According to some embodiments, if a variant is on 3′ UTR region, the DNA level description is as “c.*number”, where the number is an integer number, which indicating the distance between the variant to the last coding nucleotide. It is obtained by counting the number of bases from the variants position (or the closest ending position of exon pair coordinates, if a variant is on the intronic region) to the starting position of the pair coordinates where the variant (or the closest ending position) is located, and then adding the length of each previous coordinates pair until reaching the last coding nucleotide.

According to some embodiments, if a variant is not classified as either one of the UTR regions, the DNA level description is as “c.number”, where the number is an integer number, which indicates the distance between the variant to the first coding nucleotide. It is obtained by counting the number of bases from the variant closest starting or ending position of exon pair coordinates, and adding the length of each following coordinates pair until reaching the 1st coding nucleotide.

According to some embodiments, if a variant is in an intronic region, the DNA level description will be added by a “+” or “−” sign and then followed by a number, where the number is an integer number, which indicates the distance between the variant to closest nucleotide, which is within an exonic region. It is obtained by counting the number of bases from the variants position to the closest nucleotide base, which is within any of mRNA segments. If the closest base is the starting position of an mRNA segment, the “−” sign is used for the annotation. Otherwise, the “+” sign will be used.

### Coding DNA Sequence (CDS) Region

According to some embodiments, as shown in step 520 of FIG. 5, the program may determine if a variant is located in a non-coding region. Otherwise, it is located in a CDS region, and its annotation includes both DNA and protein level description, as described herein.

According to some embodiments, the DNA level description is as “c.number”, where the number is an integer number, which indicates the distance between the variant to the 1st coding nucleotide. It is obtained by counting the number of bases from the 1st coding nucleotide through all bases, which are within exonic regions, until the variant position is reached.

According to some embodiments, if a variant is located at exonic region and inside of CDS, the annotation includes both DNA and protein-level descriptions. The protein-level description comprises the following strings: “p.”, “letter”, “number”, and “string”. The “letter” is a single letter amino acid name, which refers to the amino acid on the wild type protein sequence. The “string” can be a single letter amino acid name, which refers to the amino acid on protein sequence after the variant happens if the protein-level variation is involved with single amino acid substitution or remains unchanged. Otherwise, it can be used to indicate the changes of deletion and/or insertion in protein level, which will be described herein. For example, “p.A100G” indicates that the 100th amino acid of the wild type protein sequence, alanine (A) mutated as glycine (G).

According to some embodiments, the reference amino acid is obtained by checking the chromosomal coordinates of the codon where the variant located. The three nucleotide bases of the codon are obtained by searching the chromosomal coordinates of the codon against the human genome build (hg19). Once the codon is retrieved, the translation of the codon from DNA to protein is the amino acid of the protein sequence before the variation.

According to some embodiments, the mutated amino acid is obtained according to the modified nucleotide sequence by substituting, deleting, and/or inserting the relevant nucleotide bases of the variant. Once the modified nucleotide sequence is obtained, the translation from DNA to protein sequence is performed. Once the comparison between original and the new protein sequence is done, the program can indicate the protein sequence changes caused by the variant changes on DNA sequence.

### Variant Type

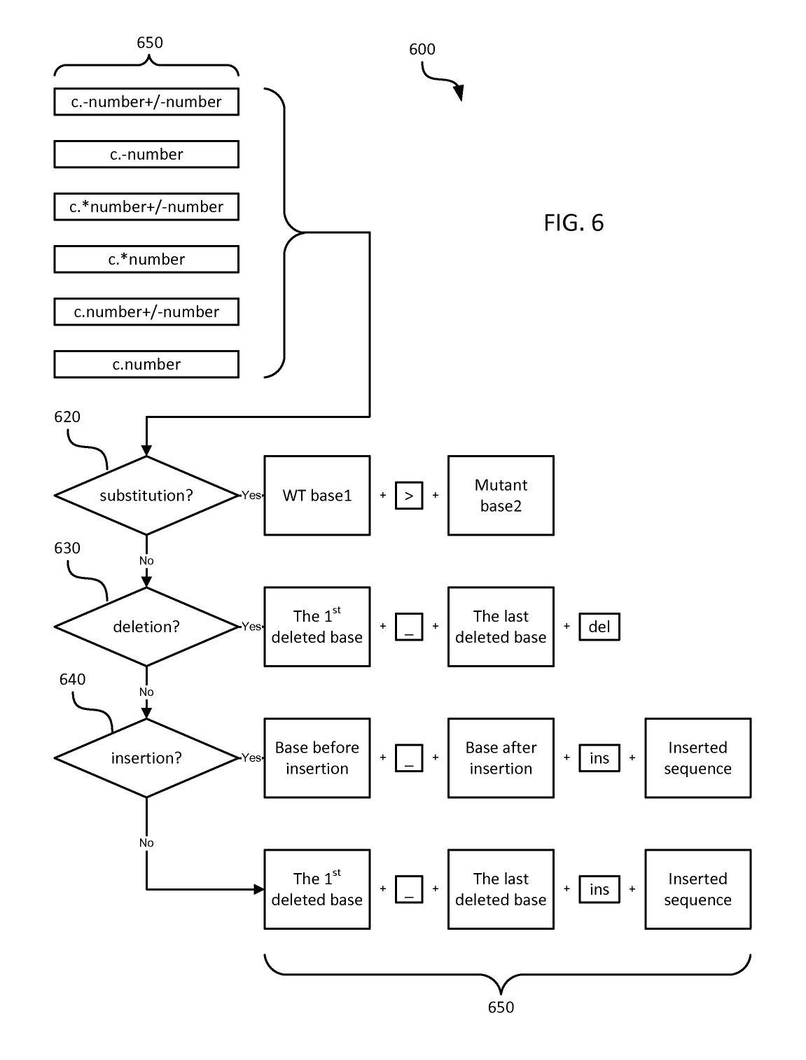

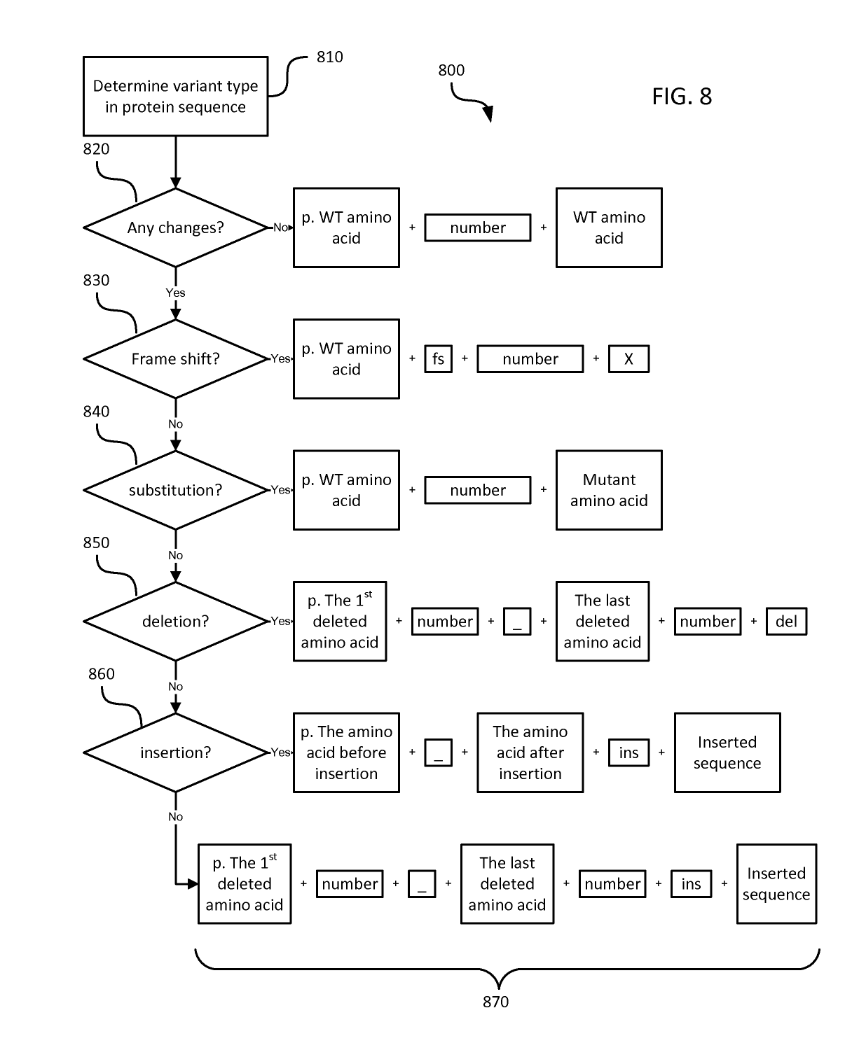

Variants can be classified according to the type of changes on both DNA level description (FIG. 6) and protein level description (FIG. 8). According to some embodiments, as shown in FIG. 6, an annotation work flow chart 600 allows users to determine a variant type and DNA level description. The types include substitution, deletion, insertion, and indel. Classification of a variant type and the corresponding annotation are described below. A deletion and/or insertion in DNA sequence can cause frame shift if the number of involved nucleotide bases divided by three and the remainder is not equal to zero. Steps 620, 630, and 640 relate to determinations made. Based on these steps, annotations 650 may be applied. The annotations are described herein.

According to some embodiments, as shown in step 620 of FIG. 6, the program determines whether one or more inputs 610 are substitutions. A substitution is defined as a single nucleotide base change in the DNA level or a single amino acid change in the protein level. Followed by the “c.number”, the DNA level description comprises “base_a”, “>”, and “base_b”. Both “base_a” and “base_b” are the single nucleotide (A, T, C, or G) before and after the variation, respectively.

According to some embodiments, as shown in step 630 of FIG. 6, the program determines whether one or more inputs 610 are deletions. If a variant is called as a deletion in a variant report, the DNA level description comprises “c.”, “number”, “_”, “number”, and “del”. Each “number” is an integer number, indicating the nucleotide bases, which are involved in the variant changes. The first “number” and the second “number” represent the first base and the last base, respectively. The method to obtain the number is described herein.

According to some embodiments, as shown in step 640 of FIG. 6, the program determines whether one or more inputs 610 are insertions. If a variant is called as a insertion in a variant report, the DNA level description comprises “c.”, “number”, “_”, “number”, “ins”, and “sequence”. Each “number” is an integer number, indicating the nucleotide bases, which are involved in the variant changes. The first “number” and the second “number” represent the two nucleotide bases, where the insertion happens in between. The method to obtain the number is described herein. The “sequence” comprises at least one nucleotide base (A, C, T, and G), which has been indicated as the inserted nucleotide bases in variant calls.

According to some embodiments, as shown in FIG. 6, the program determines whether one or more inputs 610 are indels. If a variant is called as both insertion and deletion in a variant report, the DNA level description comprises “c.”, “number”, “_”, “number”, “delins”, and “sequence”. Each “number” is an integer number, indicating the nucleotide bases, which are involved in the variant changes. The first “number” and the second “number” represent the first base and the last base of the deletion event, respectively. The method to obtain the number is described herein. The “sequence” comprises at least one nucleotide base (A, C, T, and G), which has been indicated as the inserted nucleotide bases in the insertion event.

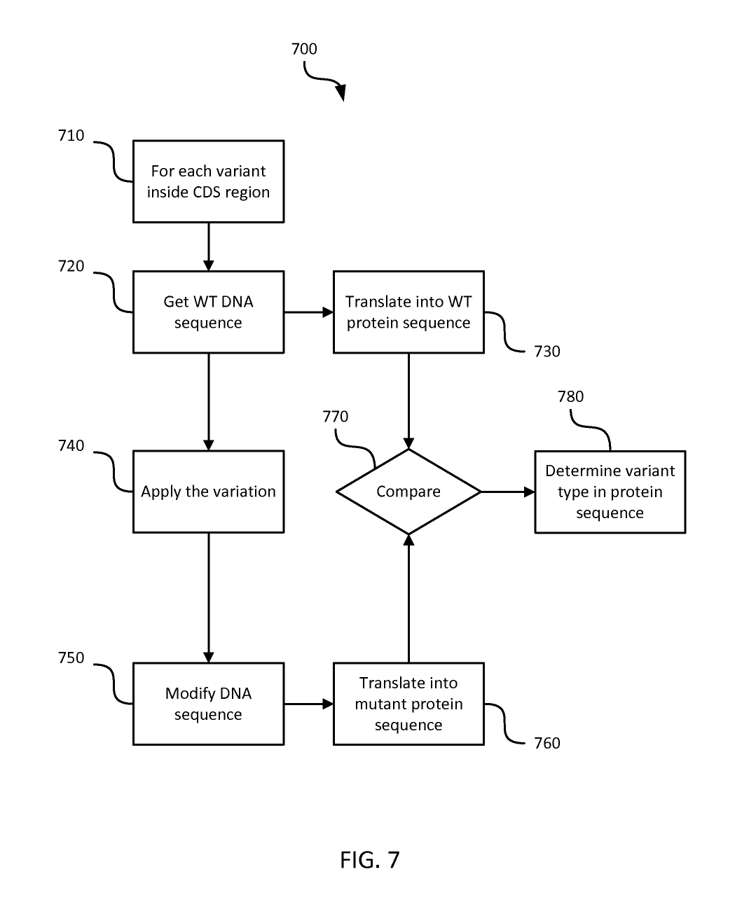

According to some embodiments, as shown in FIG. 7, a work flow chart 700 allows users to determine a variant type and a first protein level description. As shown in steps 710 and 720, for any given variant inside a CDS region, the corresponding WT DNA sequence is obtained. As shown in step 730, the WT DNA sequence is translated into a WT protein sequence. As shown in step 740, for the same given WT DNA sequence, the variation is applied. As shown in step 750, the DNA sequence is modified. As shown in step 760, the modified DNA sequences translated into the mutant proteins sequence. As shown in step 770, the WT protein sequence from step 730 is compared to the mutant proteins sequence from step 762 determine the variant type in the protein sequence.

According to some embodiments, as shown in FIG. 8, an annotation work flow chart 800 allows users to determine a variant type and a second protein level description. According to some embodiments, as shown in step 810 of FIG. 8, a process to determine a variant type in a protein sequence is started. Steps 820, 830, 840, 850, 860, relate to determinations made. Based on these steps, annotations 870 may be applied.

According to some embodiments, as shown in step 820 of FIG. 8, a determination is made regarding whether any change has occurred. If no change has occurred, the annotation comprises “p.”, “number”, and “letter”. The “letter” refers to the WT amino acid name.

According to some embodiments, as shown in step 830 of FIG. 8, a frame shift event may be considered. The frame shift event is due to the change of the amino acid translation codon. This type of protein level description is due to the deletion and/or insertion of a DNA sequence. The annotation comprises “p.”, “letter”, “number”, “fs”, “number”, and “X”. The first pair of “letter” and “number” refers to the single letter amino acid name and the position, respectively. This indicates that the first amino acid of protein sequence has been changed in the frame shift event. The frame shift also causes either earlier or later termination of the translation. The “X” represents the stop codon, and the second “number” of the description indicates the distance between the first amino acid, which is involved in this event, and the new stop codon. The method to obtain the amino acid sequence and position has been described herein.

According to some embodiments, as shown in step 840 of FIG. 8, the substitution type protein level annotation may be performed, as described herein.

According to some embodiments, as shown in step 850 of FIG. 8, The deletion type variant may have deletion of protein level description, comprising “p.”, “letter”, “number”, “_”, “letter”, “number”, and “del”. The first pair of “letter” and “number” refers to the single letter amino acid name and the position on the protein sequence of the first deleted amino acid, respectively. The second pair refers to the last amino acid, which is involved in the deletion the event. The method to obtain the amino acid sequence and position has been described herein.

According to some embodiments, as shown in step 860 of FIG. 8, the insertion type variant may have insertion of protein level description, comprising “p.”, “letter”, “number”, “_”, “letter”, “number”, “ins”, and “sequence”. The first pair of “letter” and “number” refers to the single letter amino acid name and the position, respectively, on the protein sequence of the amino acid, where the insertion sequence is followed. The second pair refers to the second amino acid. The “sequence” is the inserted amino acid sequence, comprising single letter amino acid name, which is inserted between the first and second amino acid. The method to obtain the amino acid sequence and position has been described herein.

According to some embodiments, as shown in step 870 of FIG. 8, the indel type variant may have both deletion and insertion events in the protein sequence as well. This results in the indel type of protein level description, comprising “p.”, “letter”, “number”, “_”, “letter”, “number”, “ins”, and “sequence”. The first pair of “letter” and “number” refers to the single letter amino acid name and the position, respectively. This represents to the first amino acid of protein sequence has been deleted in the event.

The second pair refers to the last amino acid, which was deleted in the deletion event. The “sequence” is the inserted amino acid sequence, comprising at least one single letter amino acid name, which is inserted between the first and second amino acid after the deletion event. The method to obtain the amino acid sequence and position has been described herein.

### Filtering Variants

According to some embodiments, the program filters variants through a process comprising one or more of the following criteria: a) by population frequency and times of occurrence, b) by variant location, c) by family history inheritance pattern, and d) by normal control list. A normal control list may be a list based on a population study. The normal controls may comprise unaffected controls (i.e., individuals that are unaffected by a candidate variant). The variants survived from the process are candidate variants of proposed genetic model and provided by an output to molecular geneticists for further evaluation.

According to some embodiments, a list of variants may be filtered by population frequency and/or number of occurrences. Population information may come from database sources such as dbSNP, 1000 genome, and ESP. For each source, the frequency and number of occurrences of each variant are retrieved, if they are available, and compared independently to the minimum cutoff values, which are predetermined or user-selected. The default values of frequency and times are 1% and 5 for recessive model, and 0.1% and 3 for dominant model. According to some embodiments, to be classified as a common SNP, both frequency and occurences thresholds must be satisfied. According to some embodiments, to be classified as a common SNP, either a frequency threshold or an occurrences threshold must be satisfied. The common SNP classification from any source may lead to the elimination of this variant.

According to some embodiments, a list of variants may be filtered by variant location. Based on variant's position relative to a gene transcript, variants can be classified into one of three groups: intergenic, intronic, and exonic. All variants in intergenic region may be discarded. Variants in intronic region may be saved if it is sufficiently close (e.g., based on a predetermined of user-selected number of basepair separations) to any splicing junction, or if it has been reported before by HGMD/OMIM as a disease causative mutation. For example, two basepair or less to any splicing function is defined as sufficiently close. By further example, variants in an exonic region may be saved and delivered to the next step, e.g., filtering by family history, except synonymous mutation without HGMD/OMIM records.

According to some embodiments, a list of variants may be filtered by family history inheritance pattern. Besides filtering with population occurrence and variant location, a variant set may be further narrowed down based on proposed genetic model and family history information. For example, an autosomal model shrinks the set by only including variants in an autosome. By further example, X-linked and Y-link models limit variants to those in chromosome X and Y, respectively.

According to some embodiments, to enter a candidate pool, each variant must abide by Mendelian inheritance pattern. For example, a script may take each variant from an affected person as a seed and compare the genotype of the affected person to genotypes of his/her parents or other family members. An inheritance conflict leads to the removal of variants. According to some embodiments, an option to allow for de novo mutations may be provided. Such an allowance may be provided with respect to one allele only. According to some embodiments, the de novo mutation of two or more alleles at the same position may be prohibited. If only one parent was sequenced, the genotype of a non-sequenced person may be estimated automatically by choosing the one with the highest probability. If a person was sequenced, but there was no variant-call at some position, the genotype of this person at that position was assumed as homozygous reference (−/−).

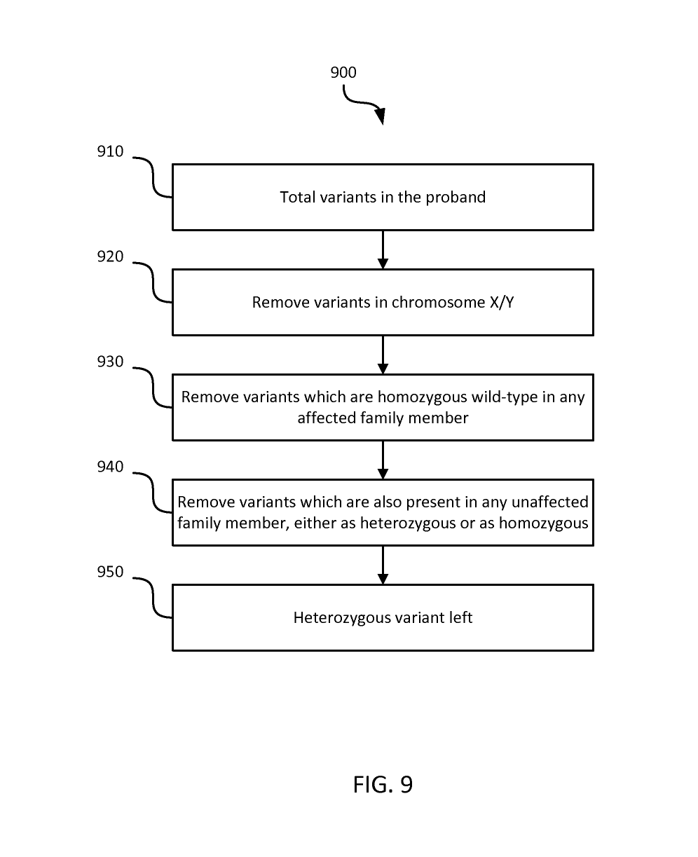

According to some embodiments, as shown in FIG. 9, a dominant model filtering program 900 may be based on an autosomal dominant model for one family. For example, all variants in step 910 passed through a Mendelian inheritance pattern had to fit with phenotypes of sequenced persons as well. Starting with a single family, a script may scan all variants in the family. In step 920, variants 910 are filtered to remove variants in the X or Y chromosome, based on a criterion. In steps 930 and 940, for an autosomal dominant model, if the genotype of this variant is a homozygous mutation (+/+) or heterozygous (+/−) for every affected person within this family, and a homozygous reference (−/−) for every unaffected person, then this variant passed the criteria and is provided by an output as a candidate variant of autosomal dominant model.

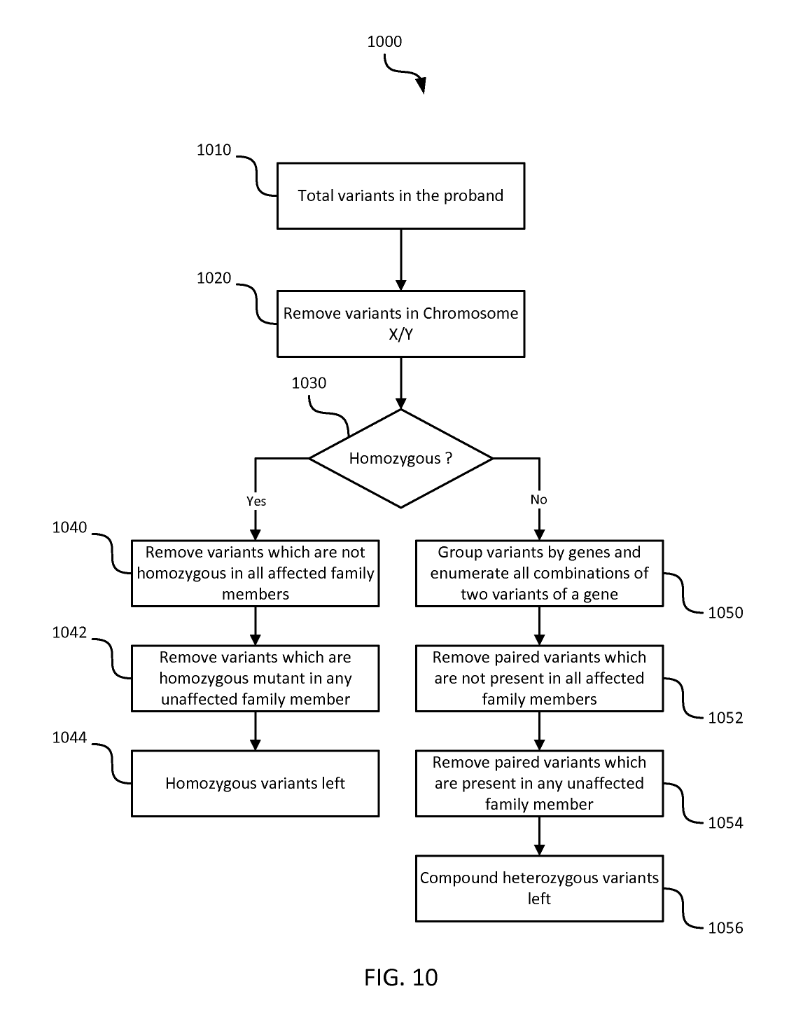

According to some embodiments, as shown in FIG. 10, a recessive model filtering program 1000 may be based on an autosomal recessive model for one family. In step 1020, variants 1010 are filtered to remove variants in the X or Y chromosome, based on a criterion. With regard to autosomal recessive model, the process may include two steps: detecting homozygous mutation (steps 1040, 1042, and 1044) and detecting compound heterozygous mutation (steps 1050, 1052, 1054, 1056). Steps 1040, 1042, and 1044 are similar to aspects of the dominant model filtering program 900, but the genotype of affected persons should be homozygous mutation (+/+) only, and for every unaffected person it could be heterozygous (+/−) or homozygous reference (−/−). Different from the dominant process, variants failed to pass the first step still have chance to be a candidate of compound heterozygous by forming a heterozygous pair. Variants located in the same genes are grouped together. Two variants were picked up from a group at each time and all combinations were enumerated. For affected persons, those two variants should be either both heterozygous (+/−), or at least one homozygous mutation (+/+). For unaffected persons, at least one variant should be homozygous reference (−/−) and the other one should be heterozygous (+/−) or homozygous reference (−/−). The variant pair that satisfies the conditions above is considered as a candidate of compound heterozygous.

All genetic models described so far are related to autosome only and no gender information is needed. However, gender information plays an important role in filtration when proposed model is X-linked or Y-linked. For example, in X-linked recessive model, all variants with hemizygous mutation (+/o) in healthy males or hemizygous reference (−/o) in affected males were removed from candidate pool. Following the pattern disclosed herein and shown in FIG. 10, variants may be removed based on identification as hemizygous mutation or hemizygous reference. For example, at or in addition to steps 1040, 1042, 1044, 1050, 1052, 1054, and 1056, a candidate hemizygous variant may be removed if it (a) presents in at least one unaffected male family member or normal control as a hemizygous variant, (b) presents in at least one unaffected female family member or normal control as a homozygous variant, or (c) does not present in at least one affected family member.

According to some embodiments, a list of variants may be filtered by normal control list. The normal control list comprises persons assumed to be unaffected and lack of causative mutations related to the current project. The selection of normal controls may be based on reported phenotypes and personal experience. Variants from normal controls may be deposited in an internal database and contrasted to all candidate variants or variant pairs. The variants may be removed from the candidate set if at least one exactly hit can be found from the normal control set.

According to some embodiments, the system may determine a treatment plan based on a genetic influence for an identified condition. For example, upon determining a genetic influence by filtering variants, the system may correlate the genetic influence with one or more treatment plans. For example, a lookup table may be provided with a pairing of genetic influences with one or more treatment plans. By further example, a lookup table may be provided with a set of treatment plans correlated with one or more genetic influences, wherein each of the treatment plans is provided with a probability of being a proper match with a respective genetic influence. By further example, a lookup table may be provided with a range of treatment plans for selection by a user (e.g., a physician).

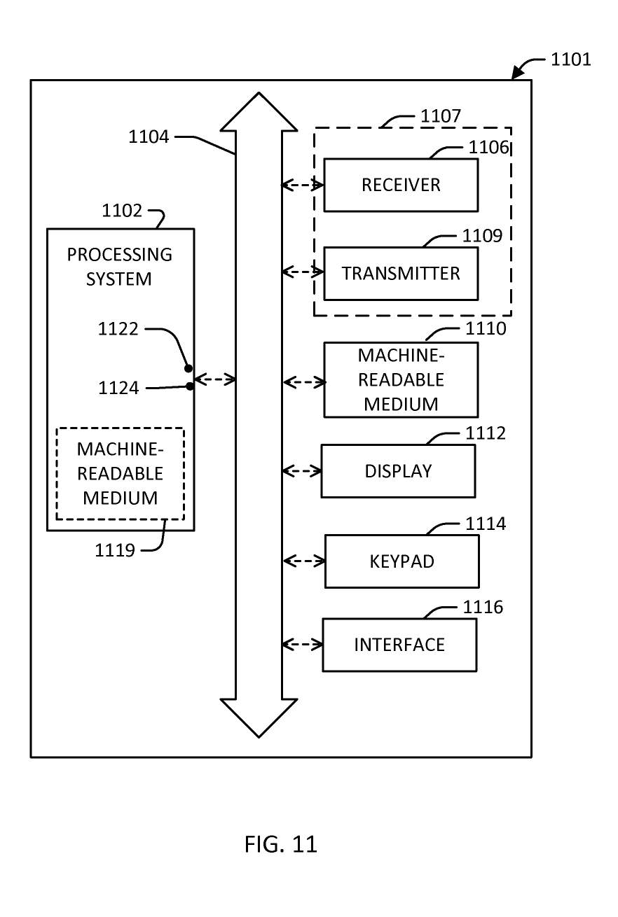

FIG. 11 is a conceptual block diagram illustrating an example of a system, in accordance with various aspects of the subject technology. A system 1101 may be, for example, a client device (e.g., client device 1202a, 1202b, 1202c, 1202d) or a server (e.g., server 1206). The system 1101 may include a processing system 1102. The processing system 1102 is capable of communication with a receiver 1106 and a transmitter 1109 through a bus 1104 or other structures or devices. It should be understood that communication means other than busses can be utilized with the disclosed configurations. The processing system 1102 can generate audio, video, multimedia, and/or other types of data to be provided to the transmitter 1109 for communication. In addition, audio, video, multimedia, and/or other types of data can be received at the receiver 1106, and processed by the processing system 1102.

The processing system 1102 may include a processor for executing instructions and may further include a machine-readable medium 1119, such as a volatile or non-volatile memory, for storing data and/or instructions for software programs. The instructions, which may be stored in a machine-readable medium 1110 and/or 1119, may be executed by the processing system 1102 to control and manage access to the various networks, as well as provide other communication and processing functions. The instructions may also include instructions executed by the processing system 1102 for various user interface devices, such as a display 1112 and a keypad 1114. The processing system 1102 may include an input port 1122 and an output port 1124. Each of the input port 1122 and the output port 1124 may include one or more ports. The input port 1122 and the output port 1124 may be the same port (e.g., a bi-directional port) or may be different ports.

The processing system 1102 may be implemented using software, hardware, or a combination of both. By way of example, the processing system 1102 may be implemented with one or more processors. A processor may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable device that can perform calculations or other manipulations of information.

A machine-readable medium can be one or more machine-readable media. Software shall be construed broadly to mean instructions, data, or any combination thereof, whether referred to as software, firmware, middleware, microcode, hardware description language, or otherwise. Instructions may include code (e.g., in source code format, binary code format, executable code format, or any other suitable format of code).

Machine-readable media (e.g., 1119) may include storage integrated into a processing system, such as might be the case with an ASIC. Machine-readable media (e.g., 1110) may also include storage external to a processing system, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device. Those skilled in the art will recognize how best to implement the described functionality for the processing system 1102. According to one aspect of the disclosure, a machine-readable medium is a computer-readable medium encoded or stored with instructions and is a computing element, which defines structural and functional interrelationships between the instructions and the rest of the system, which permit the instructions' functionality to be realized. In one aspect, a machine-readable medium is a non-transitory machine-readable medium, a machine-readable storage medium, or a non-transitory machine-readable storage medium. In one aspect, a computer-readable medium is a non-transitory computer-readable medium, a computer-readable storage medium, or a non-transitory computer-readable storage medium. Instructions may be executable, for example, by a client device or server or by a processing system of a client device or server. Instructions can be, for example, a computer program including code.

An interface 1116 may be any type of interface and may reside between any of the components shown in FIG. 11. An interface 1116 may also be, for example, an interface to the outside world (e.g., an Internet network interface). A transceiver block 1107 may represent one or more transceivers, and each transceiver may include a receiver 1106 and a transmitter 1109. A functionality implemented in a processing system 1102 may be implemented in a portion of a receiver 1106, a portion of a transmitter 1109, a portion of a machine-readable medium 1110, a portion of a display 1112, a portion of a keypad 1114, or a portion of an interface 1116, and vice versa.

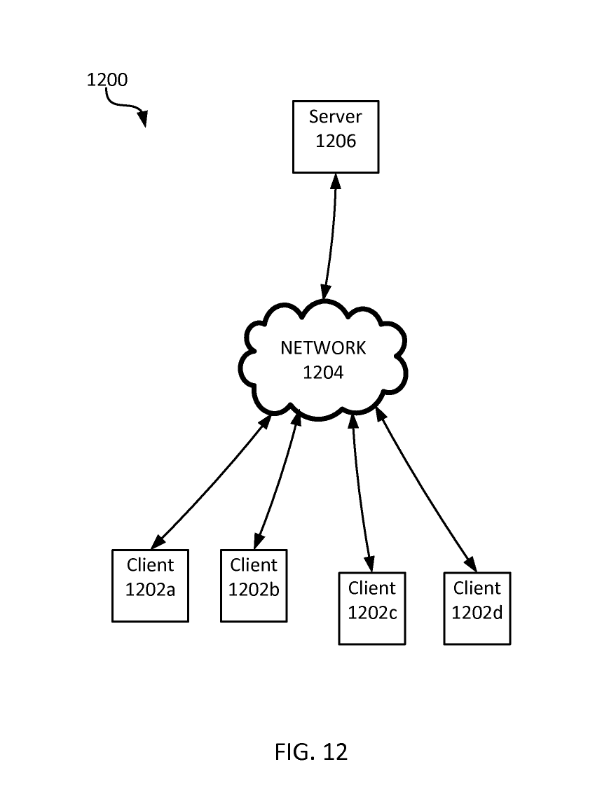

FIG. 12 illustrates a simplified diagram of a system 1200, in accordance with various embodiments of the subject technology. The system 1200 may include one ore more remote client devices 1202 (e.g., client devices 1202a, 1202b, 1202c, and 1202d) in communication with a server computing device 1206 (server) via a network 1204. In some embodiments, the server 1206 is configured to run applications that may be accessed and controlled at the client devices 1202. For example, a user at a client device 1202 may use a web browser to access and control an application running on the server 1206 over the network 1204. In some embodiments, the server 1206 is configured to allow remote sessions (e.g., remote desktop sessions) wherein users can access applications and files on the server 1206 by logging onto the server 1206 from a client device 1202. Such a connection may be established using any of several well-known techniques such as the Remote Desktop Protocol (RDP) on a Windows-based server.

By way of illustration and not limitation, in one aspect of the disclosure, stated from a perspective of a server side (treating a server as a local device and treating a client device as a remote device), a server application is executed (or runs) at a server 1206. While a remote client device 1202 may receive and display a view of the server application on a display local to the remote client device 1202, the remote client device 1202 does not execute (or run) the server application at the remote client device 1202. Stated in another way from a perspective of the client side (treating a server as remote device and treating a client device as a local device), a remote application is executed (or runs) at a remote server 1206.

By way of illustration and not limitation, a client device 1202 can represent a computer, a mobile phone, a laptop computer, a thin client device, a personal digital assistant (PDA), a portable computing device, or a suitable device with a processor. In one example, a client device 1202 is a smartphone (e.g., iPhone, Android phone, Blackberry, etc.). In certain configurations, a client device 1202 can represent an audio player, a game console, a camera, a camcorder, an audio device, a video device, a multimedia device, or a device capable of supporting a connection to a remote server. In one example, a client device 1202 can be mobile. In another example, a client device 1202 can be stationary. According to one aspect of the disclosure, a client device 1202 may be a device having at least a processor and memory, where the total amount of memory of the client device 1202 could be less than the total amount of memory in a server 1206. In one example, a client device 1202 does not have a hard disk. In one aspect, a client device 1202 has a display smaller than a display supported by a server 1206. In one aspect, a client device may include one or more client devices.

In some embodiments, a server 1206 may represent a computer, a laptop computer, a computing device, a virtual machine (e.g., VMware® Virtual Machine), a desktop session (e.g., Microsoft Terminal Server), a published application (e.g., Microsoft Terminal Server) or a suitable device with a processor. In some embodiments, a server 1206 can be stationary. In some embodiments, a server 1206 can be mobile. In certain configurations, a server 1206 may be any device that can represent a client device. In some embodiments, a server 1206 may include one or more servers.

In one example, a first device is remote to a second device when the first device is not directly connected to the second device. In one example, a first remote device may be connected to a second device over a communication network such as a Local Area Network (LAN), a Wide Area Network (WAN), and/or other network.

When a client device 1202 and a server 1206 are remote with respect to each other, a client device 1202 may connect to a server 1206 over a network 1204, for example, via a modem connection, a LAN connection including the Ethernet or a broadband WAN connection including DSL, Cable, T1, T3, Fiber Optics, Wi-Fi, or a mobile network connection including GSM, GPRS, 3G, WiMax or other network connection. A network 1204 can be a LAN network, a WAN network, a wireless network, the Internet, an intranet or other network. A network 1204 may include one or more routers for routing data between client devices and/or servers. A remote device (e.g., client device, server) on a network may be addressed by a corresponding network address, such as, but not limited to, an Internet protocol (IP) address, an Internet name, a Windows Internet name service (WINS) name, a domain name or other system name. These illustrate some examples as to how one device may be remote to another device. But the subject technology is not limited to these examples.

According to certain embodiments of the subject technology, the terms “server” and “remote server” are generally used synonymously in relation to a client device, and the word “remote” may indicate that a server is in communication with other device(s), for example, over a network connection(s).

According to certain embodiments of the subject technology, the terms “client device” and “remote client device” are generally used synonymously in relation to a server, and the word “remote” may indicate that a client device is in communication with a server(s), for example, over a network connection(s).

In some embodiments, a “client device” may be sometimes referred to as a client or vice versa. Similarly, a “server” may be sometimes referred to as a server device or vice versa.

In some embodiments, the terms “local” and “remote” are relative terms, and a client device may be referred to as a local client device or a remote client device, depending on whether a client device is described from a client side or from a server side, respectively. Similarly, a server may be referred to as a local server or a remote server, depending on whether a server is described from a server side or from a client side, respectively. Furthermore, an application running on a server may be referred to as a local application, if described from a server side, and may be referred to as a remote application, if described from a client side.

In some embodiments, devices placed on a client side (e.g., devices connected directly to a client device(s) or to one another using wires or wirelessly) may be referred to as local devices with respect to a client device and remote devices with respect to a server. Similarly, devices placed on a server side (e.g., devices connected directly to a server(s) or to one another using wires or wirelessly) may be referred to as local devices with respect to a server and remote devices with respect to a client device.

As used herein, the word “module” refers to logic embodied in hardware or firmware, or to a collection of software instructions, possibly having entry and exit points, written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

It is contemplated that the modules may be integrated into a fewer number of modules. One module may also be separated into multiple modules. The described modules may be implemented as hardware, software, firmware or any combination thereof. Additionally, the described modules may reside at different locations connected through a wired or wireless network, or the Internet.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as “an aspect” may refer to one or more aspects and vice versa. A phrase such as “an embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such “an embodiment” may refer to one or more embodiments and vice versa. A phrase such as “a configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as “a configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While certain aspects and embodiments of the invention have been described, these have been presented by way of example only, and are not intended to limit the scope of the invention. Indeed, the novel methods and systems described herein may be embodied in a variety of other forms without departing from the spirit thereof. The accompanying claims and their equivalents are intended to cover such forms or modifications as would fall within the scope and spirit of the invention.

What is claimed is:

1. A computer-implemented method of diagnosing a genetic influence for a condition in a proband, comprising:
by a processor and from a list of genetic variants, removing variants not compatible with a Mendelian inheritance model determined by an input to the processor and based on a family history of the proband;
from the list of variants, removing variants that are present in unaffected controls above a specified frequency and specified occurrence that are determined by the input; and
by a processor, identifying a genetic influence for the condition, based on one or more remaining variants in the list.

2. The method of claim 1, further comprising determining a treatment plan based on the genetic influence.

3. The method of claim 1, wherein the identifying a genetic influence comprises estimating a probability that one of more of the remaining variants significantly influences at least one of clinical signs or symptoms of the proband.

4. The method of claim 1, wherein the removing variants not compatible with the Mendelian inheritance model comprises comparing a genotype from the proband to a genotype from at least one family member.

5. The method of claim 1, wherein the removing variants not compatible with the Mendelian inheritance model further comprises removing a heterozygous variant of the proband that exists in at least one unaffected family member as a homozygous variant.

6. The method of claim 1, wherein the Mendelian inheritance model is a dominant model.

7. The method of claim 6, wherein the removing variants not compatible with the Mendelian inheritance model further comprises removing a heterozygous variant of the proband if it exists in at least one unaffected family member or does not exist in at least one affected family member.

8. The method of claim 6, wherein the removing variants that are present in unaffected controls comprises removing a candidate heterozygous variant that presents in at least one unaffected control as either a heterozygous or homozygous variant.

9. The method of claim 1, wherein the Mendelian inheritance model is a recessive model.

10. The method of claim 9, wherein the removing variants not compatible with the Mendelian inheritance model comprises removing a candidate homozygous variant that at least one of (a) presents in at least one unaffected family member or unaffected control as a homozygous variant or (b) does not present in at least one affected family member.

11. The method of claim 9, wherein the removing variants that are present in unaffected controls comprises removing a candidate pair of compound heterozygous variants that present in at least one unaffected control.

12. The method of claim 1, wherein the Mendelian inheritance model is a sex-linked recessive model.

13. The method of claim 12, wherein the removing variants not compatible with the Mendelian inheritance model comprises removing a candidate variant that at least one of (a) presents in at least one unaffected male family member or male unaffected control as a hemizygous variant, (b) presents in at least one unaffected female family member or female unaffected control as a homozygous variant, or (c) does not present in at least one affected family member.

14. The method of claim 1, wherein the list is an index list, and further comprising forming the index list, from a master list of more genetic variants than are in the index list, by the following steps:
annotating a description of variants based on locations of at least one of (a) mutations in respective genes, or (b) amino acid alterations in affected proteins;
annotating population frequencies of variants;
annotating disease information associated with variants;
annotating with evolutionary conservation indicators at variant positions; and
annotating at least one prediction of a deleterious effect of at least one variant.

15. The method of claim 1, wherein the list is an index list, and further comprising forming the index list, from a master list of more genetic variants than are in the index list, by the following steps:
from the master list, removing common variants that satisfy a user-defined threshold;
from the master list, removing variants in at least one intergenic region; and
from the master list, removing deep intronic variants and synonymous variants that do not have associated records in a selected database.

16. The method of claim 15, wherein common variants comprise single nucleotide polymorphisms (SNPs), deletions, insertions, and indels.

17. A computer implementation system for diagnosing a genetic influence for a condition in a proband, comprising:
an input module that, by a processor, receives an input from a user;
an inheritance filtering module that, by a processor, based on the input, and from a list of variants, removes variants not compatible with a Mendelian inheritance model, determined by an input to the processor, and based on a family history of the proband;
a control filtering module that, by a processor, based on the input, and from the list of variants, removes variants that are present in unaffected controls above a specified frequency and specified occurrence that are determined by the input;
an identifying module that, by a processor, identifies a genetic influence for the condition, based on one or more remaining variants in the list; and
an output module that, by a processor, outputs the one or more remaining variants to a display.

18. The computer implementation system of claim 17, further comprising a determining module that, by a processor, determines a treatment plan based on the genetic influence.

19. The method of claim 1, wherein the identifying module is configured to identify genetic influence by estimating a probability that one of more of the remaining variants significantly influences at least one of clinical signs or symptoms of the proband.

20. The computer implementation system of claim 17, wherein the input comprises a selection between a recessive model of Mendelian inheritance and a dominant model of Mendelian inheritance.

21. The computer implementation system of claim 17, wherein the input comprises a selection between an autosomal model of Mendelian inheritance, an X-linked model of Mendelian inheritance, and a Y-linked model of Mendelian inheritance.

22. The computer implementation system of claim 17, wherein the input comprises a selection of whether to allow de novo mutations.

23. The computer implementation system of claim 17, wherein the list is an index list, the computer implementation system further comprising a forming module that, by a processor, forms the index list, from a master list of more genetic variants than are in the index list.

24. The computer implementation system of claim 23, wherein the forming module, by a processor:
from the master list, removes common variants that satisfy a user-defined threshold;
from the master list, removes variants in at least one intergenic region; and
from the master list, removes deep intronic variants and synonymous variants that do not have associated records in a selected database.

25. A machine-readable medium comprising machine-readable instructions for causing a processor to execute a method comprising:
(1) receiving an input from a user;
(2) from a list of genetic variants, removing variants not compatible with a Mendelian inheritance model determined by an input to the processor and based on a family history of the proband;
(3) from the list of variants, removing variants that are present in unaffected controls above a specified frequency and specified occurrence that are determined by the input; and
(4) identifying a genetic influence for the condition, based on one or more remaining variants in the list.

26. The machine-readable medium of claim 25, wherein the list is an index list, and wherein the method further comprises forming the index list, from a master list of more genetic variants than are in the index list.

27. The machine-readable medium of claim 26, wherein forming the index list comprises:
within the list of variants, annotating a description of variants based on locations of at least one of (a) mutations in respective genes, or (b) amino acid alterations in affected proteins;
within the list of variants, annotating population frequencies of variants;
within the list of variants, annotating disease information associated with variants;
within the list of variants, annotating with evolutionary conservation indicators at variant positions; and
within the list of variants, annotating at least one prediction of a deleterious effect of at least one variant.

28. The machine-readable medium of claim 26, wherein forming the index list comprises:
from the master list, removing common variants that satisfy a user-defined threshold;
from the master list, removing variants in at least one intergenic region; and
from the master list, removing deep intronic variants and synonymous variants that do not have associated records in a selected database.

29. The machine-readable medium of claim 25, wherein the input comprises:
a selection between a recessive model of Mendelian inheritance and a dominant model of Mendelian inheritance;
a selection between an autosomal model of Mendelian inheritance, an X-linked model of Mendelian inheritance, and a Y-linked model of Mendelian inheritance; and
a selection of whether to allow de novo mutations.
